(19) United States
(12) Patent Application Publication
(10) Pub. No.: US 2020/0203851 A1
(43) Pub. Date: Jun. 25, 2020

(54) MULTIAXIAL ANTENNA, WIRELESS COMMUNICATION MODULE, AND WIRELESS COMMUNICATION DEVICE

(71) Applicant: HITACHI METALS, LTD., Minato-ku, Tokyo (JP)

(72) Inventors: Yasunori TAKAKI, Minato-ku, Tokyo (JP); Kenji HAYASHI, Minato-ku, Tokyo (JP)

(21) Appl. No.: 16/620,985

(22) PCT Filed: Jul. 31, 2018
(86) PCT No.: PCT/JP2018/028687

§ 371 Date: Dec. 10, 2019

(30) Foreign Application Priority Data
Aug. 1, 2017 (JP) 2017-149340

(51) Int. Cl. H01Q 21/08; H01Q 9/42; H01Q 1/48

(52) U.S. Cl. CPC H01Q 21/08; H01Q 1/48; H01Q 9/42

(57) ABSTRACT

A multiaxial antenna includes an antenna unit, the antenna unit including a planar antenna which includes a planar radiation conductor and a ground conductor, the planar radiation conductor and the ground conductor being spaced away from each other in a third axis direction in a first right-handed Cartesian coordinate system which has first, second and third axes, and at least one linear antenna which is spaced away from the planar antenna in a first axis direction, the linear antenna including one or two linear radiation conductors extending in a second axis direction.

### TECHNICAL FIELD

The present application relates to a multiaxial antenna, a wireless communication module and a wireless communication device.

### BACKGROUND ART

As the Internet communication increases and development of high picture quality video technologies advances, the communication speed required for wireless communication also increases, and high frequency wireless communication techniques which are capable of transmission and reception of more information have been demanded. As the frequency of the carrier wave increases, the straightforwardness of an electromagnetic wave improves and, therefore, the communicable cell radius of base stations which perform transmission and reception of electric waves with wireless terminals decreases. Therefore, in wireless communication with short wavelength carrier waves, generally, the base stations are arranged at higher density than in conventional systems.

As a result, the number of base stations which are close to a wireless communication terminal increases, and in some cases, it is necessary to select a specific one of the close base stations which is capable of high-quality communication. That is, in some cases, the wireless communication terminal needs to have an antenna which can radiate electric waves over a broad azimuthal range and which has high directivity.

For example, Patent Document No. 1 discloses a diversity antenna for receiving electric waves from a direction at which the intensity of electric waves is high.

### CITATION LIST

### Patent Literature

Patent Document No. 1: Japanese Laid-Open Patent Publication No. 2016-146564

### SUMMARY OF INVENTION

### Technical Problem

The present application provides a multiaxial antenna which has directivity in two or more directions in a short wavelength band, a wireless communication module and a wireless communication device.

### Solution to Problem

A multiaxial antenna of the present disclosure includes an antenna unit, the antenna unit including a planar antenna which includes a planar radiation conductor and a ground conductor, the planar radiation conductor and the ground conductor being spaced away from each other in a third axis direction in a first right-handed Cartesian coordinate system which has first, second and third axes, and at least one linear antenna which is spaced away from the planar antenna in a first axis direction, the linear antenna including one or two linear radiation conductors extending in a second axis direction.

The planar antenna may further include a first strip conductor located between the planar radiation conductor and the ground conductor and extending in the first axis direction, part of the first strip conductor overlapping the planar radiation conductor when viewed in the third axis direction.

The first strip conductor may have a first end portion which is supplied with electric power from an external device and a second end portion which is spaced away from the first end portion in the first axis direction, and a distance in the third axis direction between the second end portion and the planar radiation conductor may be smaller than a distance in the third axis direction between the first end portion and the planar radiation conductor.

The planar antenna may further include a second strip conductor located between the planar radiation conductor and the ground conductor and extending in the second axis direction, part of the second strip conductor overlapping the planar radiation conductor when viewed in the third axis direction.

The second strip conductor may have a first end portion which is supplied with electric power from an external device and a second end portion which is spaced away from the first end portion in the second axis direction, and a distance in the third axis direction between the second end portion and the planar radiation conductor may be smaller than a distance in the third axis direction between the first end portion and the planar radiation conductor.

When viewed in the third axis direction, the one or two linear radiation conductors may not overlap the ground conductor.

When viewed in the third axis direction, the one or two linear radiation conductors may be away from an end portion of the ground conductor in the first axis direction by λ/8 or more where λ is the wavelength of a carrier wave in a frequency band used by the multiaxial antenna.

The linear antenna may include a single piece of the linear radiation conductor and may further include a power supply conductor connected with one end of the linear radiation conductor and extending in the first axis direction.

The linear antenna may include two pieces of the linear radiation conductor and may further include two power supply conductors extending in the first axis direction, the two linear radiation conductors may be aligned in the second axis direction, ends of the two power supply conductors may be respectively connected with ends of the two aligned linear radiation conductors which are adjoining each other, and the other end of one of the two power supply conductors may be grounded while the other end of the other power supply conductor is supplied with electric power from an external device.

Part of the power supply conductor may overlap the ground conductor when viewed in the third axis direction.

The multiaxial antenna may further include a dielectric which has a major surface perpendicular to the third axis direction, at least the ground conductor of the planar antenna being located inside the dielectric.

The dielectric may have a lateral surface which is adjacent to the major surface and perpendicular to the first axis, and the one or two linear radiation conductors of the linear antenna may be located close to the lateral surface.

The planar radiation conductor of the planar antenna and the one or two linear radiation conductors of the linear antenna may be located on the major surface.

The planar antenna and the linear antenna may be located inside the dielectric.

The dielectric may be a multilayer ceramic structure.

The dielectric may be a multilayer ceramic structure including a plurality of ceramic layers stacked in the third axis direction, and the one or two linear radiation conductors and the planar radiation conductor may be located at a same one of interfaces between the plurality of ceramic layers.

The multiaxial antenna may include a plurality of sets of the antenna unit, the plurality of antenna units may be aligned in the second axis direction, and the ground conductors of the plurality of antenna units may be connected in the second axis direction.

The multiaxial antenna may include a plurality of sets of the antenna unit, the plurality of antenna units may be aligned in the second axis direction, and the ground conductors of the plurality of antenna units may be connected in the second axis direction.

Another multiaxial antenna of the present disclosure includes an antenna unit, the antenna unit including a planar antenna which includes a planar radiation conductor and a ground conductor, the planar radiation conductor and the ground conductor being spaced away from each other in a third axis direction in a first right-handed Cartesian coordinate system which has first, second and third axes, and first and second linear antennas which are spaced away from the planar antenna in a first axis direction, the first and second linear antennas including one or two linear radiation conductors extending in a second axis direction, wherein the first linear antenna and the second linear antenna are aligned along the first axis with the planar antenna being interposed therebetween.

A wireless communication module of the present disclosure includes the previously-described multiaxial antenna.

A wireless communication device of the present disclosure includes: a circuit board in a second right-handed Cartesian coordinate system which has first, second and third axes, the circuit board having first and second major surfaces which are perpendicular to the third axis, first and second lateral portions which are perpendicular to the first axis, third and fourth lateral portions which are perpendicular to the second axis, and at least one of a transmission circuit and a reception circuit; and at least one set of the previously-described wireless communication module.

The wireless communication device may include a single set of the wireless communication module, and the multiaxial antenna may be located on the first major surface or the second major surface such that the lateral surface of the dielectric of the wireless communication module is close to one of the first to fourth lateral portions.

The wireless communication device may include a single set of the wireless communication module, and the multiaxial antenna may be located on one of the first to fourth lateral portions such that the lateral surface of the dielectric of the wireless communication module is close to the first major surface or the second major surface.

The wireless communication device may include at least two sets of the wireless communication module, at least one of the wireless communication modules may be located on one of the first and second major surfaces of the circuit board, and at least one of the wireless communication modules may be located on one of the first to fourth lateral portions of the circuit board.

The wireless communication device may include a plurality of sets of the wireless communication module, and the plurality of wireless communication modules may be located on the first major surface or the second major surface such that the lateral surface of the dielectric of the wireless communication modules is close to any of the first to fourth lateral portions.

The wireless communication device may include a plurality of sets of the wireless communication module, and the plurality of wireless communication modules may be located on at least one of the first to fourth lateral portions such that the lateral surface of the dielectric of the wireless communication module is close to either of the first major surface or the second major surface.

The wireless communication device may include four sets of the wireless communication module, and two of the four wireless communication modules may be located on the first major surface such that the lateral surfaces of the dielectrics of the wireless communication modules are respectively close to the first and third lateral portions, and the other two of the four wireless communication modules may be located on the second major surface such that the lateral surfaces of the dielectrics of the wireless communication modules are respectively close to the second and fourth lateral portions.

The wireless communication device may include four sets of the wireless communication module, and two of the four wireless communication modules may be respectively located on the first and second lateral portions such that the lateral surfaces of the dielectrics of the wireless communication modules are respectively close to the first major surface and the second major surface, and the other two of the four wireless communication modules may be respectively located on the third and fourth lateral portions such that the lateral surfaces of the dielectrics of the wireless communication modules are respectively close to the first major surface and the second major surface.

### Advantageous Effects of Invention

A multiaxial antenna of the present disclosure has directivity in two or more directions and is capable of transmission and reception of electromagnetic waves in a broad azimuthal range.

### BRIEF DESCRIPTION OF DRAWINGS

FIG. 1(a) is a perspective view showing one embodiment of a multiaxial antenna of the present disclosure. FIG. 1(b) is a perspective view showing a single antenna unit of the multiaxial antenna.

FIG. 2 is a schematic cross-sectional view of the multiaxial antenna taken along line A-A of FIG. 1(a).

FIG. 3 is an exploded perspective view of a strip conductor included in a planar antenna of a multiaxial antenna.

FIG. 4(a) shows an example of a power supply section for a planar antenna of a multiaxial antenna. FIG. 4(b) and FIG. 4(c) show examples of a power supply section for a linear antenna.

FIG. 5(a) and FIG. 5(b) are schematic diagrams showing the intensity distribution of an electromagnetic wave radiated from a single antenna unit of a multiaxial antenna.

FIG. 6 is a perspective view showing another embodiment of the multiaxial antenna.

FIG. 7 is a perspective view showing another embodiment of the multiaxial antenna.

FIG. 8 is a perspective view showing another embodiment of the multiaxial antenna.

FIG. 9 is a schematic cross-sectional view showing one embodiment of a wireless communication module of the present disclosure.

FIG. 10(a) and FIG. 10(b) are a schematic plan view and side view showing one embodiment of a wireless communication device of the present disclosure.

FIG. 11(a), FIG. 11(b) and FIG. 11(c) are a schematic plan view and side views showing other forms of the wireless communication device of the present disclosure.

FIG. 12(a) shows a gain distribution of the wireless communication device shown in FIG. 11, which was determined by simulation. FIG. 12(b) shows the relationship between the second right-handed Cartesian coordinate system and the directions 6 and c of the electromagnetic wave represented by the gain distribution.

FIG. 13 is a schematic cross-sectional view showing another form of the multiaxial antenna.

FIG. 14(a), FIG. 14(b) and FIG. 14(c) show other examples of the power supply section for a planar antenna and a linear antenna of the multiaxial antenna.

FIG. 15(a) and FIG. 15(b) are a schematic top view and a schematic cross-sectional view showing another form of the multiaxial antenna.

FIG. 16 is a schematic top view showing another form of the multiaxial antenna.

FIG. 17 is a schematic top view showing another form of the multiaxial antenna.

FIG. 18 is a schematic top view showing another form of the multiaxial antenna.

FIG. 19 is a schematic top view showing another form of the multiaxial antenna.

FIG. 20(a) and FIG. 20(b) are schematic top views showing other forms of the multiaxial antenna.

FIG. 21(a) and FIG. 21(b) are schematic top views showing other forms of the multiaxial antenna.

FIG. 22 is a schematic top view showing another form of the multiaxial antenna.

FIG. 23 is a schematic top view showing another form of the multiaxial antenna.

FIG. 24(a) and FIG. 24(b) are schematic cross-sectional views showing other forms of the wireless communication module.

FIG. 25 is a schematic cross-sectional view showing another form of the wireless communication module.

FIG. 26 is a schematic cross-sectional view showing another form of the wireless communication module.

FIG. 27(a), FIG. 27(b) and FIG. 27(c) are a schematic plan view and side views showing other forms of the wireless communication device.

### DESCRIPTION OF EMBODIMENTS

A multiaxial antenna, a wireless communication module and a wireless communication device of the present disclosure can be used for wireless communication in, for example, the quasi-microwave band, the centimeter wave band, the quasi-millimeter wave band and the millimeter wave band. The wireless communication in the quasi-microwave band uses as the carrier wave an electric wave which has a wavelength of 10 cm to 30 cm and a frequency of 1 GHz to 3 GHz. The wireless communication in the centimeter wave band uses as the carrier wave an electric wave which has a wavelength of 1 cm to 10 cm and a frequency of 3 GHz to 30 GHz. The wireless communication in the millimeter wave band uses as the carrier wave an electric wave which has a wavelength of 1 mm to 10 mm and a frequency of 30 GHz to 300 GHz. The wireless communication in the quasi-millimeter wave band uses as the carrier wave an electric wave which has a wavelength of 10 mm to 30 mm and a frequency of 10 GHz to 30 GHz. In the wireless communication in these bands, the size of the planar antenna is of the order of several centimeters to sub-millimeters. For example, if a quasi-microwave/centimeter wave/quasi-millimeter wave/millimeter wave wireless communication circuit is formed by a multilayer ceramic sintered substrate, a multiaxial antenna of the present disclosure can be mounted to the multilayer ceramic sintered substrate. Hereinafter, in the present embodiment, a planar array antenna is described with an example where the carrier wave of a quasi-microwave, centimeter wave, quasi-millimeter wave or millimeter wave has a frequency of 30 GHz and a wavelength λ of 10 mm unless otherwise specified.

In the present disclosure, right-handed Cartesian coordinate systems are employed for illustrating the arrangement of components, directions, etc. Specifically, the first right-handed Cartesian coordinate system has x, y and z axes which are orthogonal to one another, and the second right-handed Cartesian coordinate system has u, v and w axes which are orthogonal to one another. To distinguish the first right-handed Cartesian coordinate system and the second right-handed Cartesian coordinate system and specify the order of the axes of the right-handed coordinate systems, the axes are marked with alphabet letters, x, y, z and u, v, w, although these may also be referred to as the first, second and third axes.

In the present disclosure, if two directions are described as being “in accord”, it means that the angle between the two directions is approximately in the range of 00 to about 45°. The term “parallel” means that the angle between two planes, the angle between two lines, or the angle between a plane and a line is in the range of 00 to about 100. In illustrating a direction by referring to an axis, the positive (+) side and the negative (−) side of the axis are separately described when it is important whether the direction is the positive (+) direction or the negative (−) direction of the axis relative to the reference. On the other hand, the direction is simply mentioned as “axis direction” when it is important which axis the direction is along and it does not matter whether the direction is the positive (+) direction or the negative (−) direction of the axis.

### First Embodiment

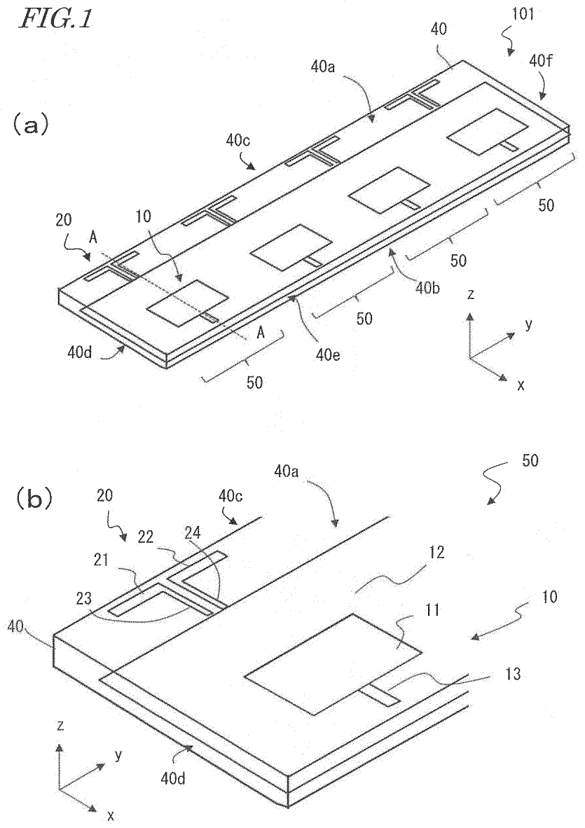

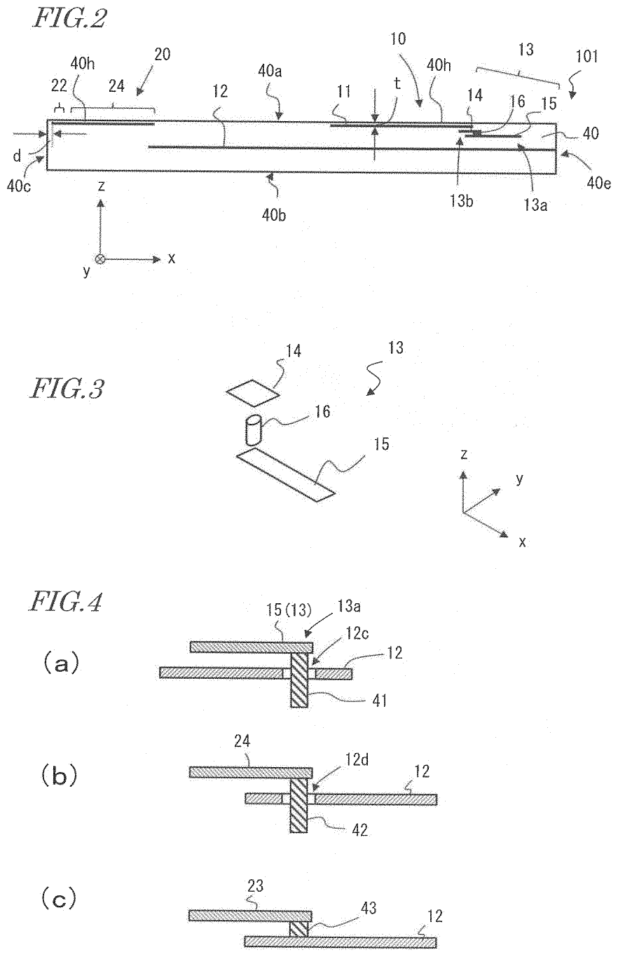

An embodiment of a multiaxial antenna of the present disclosure is described. FIG. 1(a) is a schematic perspective view showing a multiaxial antenna 101 of the present disclosure. FIG. 2 is a schematic cross-sectional view of the multiaxial antenna 101 taken along line A-A of FIG. 1(a). The multiaxial antenna 101 includes a plurality of antenna units 50. In the present embodiment, the multiaxial antenna 101 includes four antenna units 50, although the number of antenna units 50 is not limited to four. The multiaxial antenna 101 may include at least one antenna unit 50.

FIG. 1(b) is a perspective view showing one of the antenna units 50 of the multiaxial antenna 101. Each of the antenna units 50 includes a planar antenna 10 and a linear antenna 20. As shown in FIG. 1(b), in the first right-handed Cartesian coordinate system, the plurality of antenna units 50 are aligned in the y direction. As will be described later, the multiaxial antenna 101 includes a dielectric 40, and the planar antenna 10 and the linear antenna 20 of each of the antenna units 50 are provided in the dielectric 40. In FIG. 1(a) and subsequent perspective views, the dielectric 40 is shown as being transparent in order to reveal the internal structure of the multiaxial antenna 101.

The planar antenna 10 is also referred to as “patch antenna”. The planar antenna 10 includes a planar radiation conductor 11 and a ground conductor 12. The planar radiation conductor 11 and the ground conductor 12 are spaced away from each other in the z-axis direction. The planar radiation conductor 11 is arranged generally parallel to the xy plane. The planar radiation conductor 11 is a radiation element which is capable of radiating electric waves. The planar radiation conductor 11 has such a shape that can achieve required radiation characteristics and impedance matching.

In the present embodiment, the planar radiation conductor 11 has a rectangular shape elongated in the y direction (which has a longitudinal dimension). The planar radiation conductor 11 may have any other shape, such as square, circular, etc. The planar radiation conductor 11 generally has dimensions which are determined based on ½ of the wavelength λ of the carrier wave. For example, when the relative permittivity of the dielectric 40 is 8, the planar radiation conductor 11 has a length of 2.8 mm in the y direction and a length of 1.7 mm in the x direction.

The ground conductor 12 is a ground electrode which is coupled with the reference potential. When viewed in the z-axis direction, the ground conductor 12 is located in a region which is greater than the planar radiation conductor 11 and which includes at least a region under the planar radiation conductor 11. In the present embodiment, the ground conductor 12 is connected with the ground conductor 12 of a neighboring antenna unit 50.

The planar antenna 10 includes a power supply section which is electromagnetically coupled with the planar radiation conductor 11 and which is capable of supplying signal power to the planar radiation conductor 11. For example, a conductor for supply of signal power may be directly connected with the planar radiation conductor 11. Alternatively, signal power may be supplied to the planar radiation conductor 11 by electromagnetic field coupling via a strip conductor, slot power supply, etc. A planar conductor layer which has a slot between the planar radiation conductor 11 and a strip conductor may be provided such that power supply can be realized through the slot of the planar conductor layer. When power supply is realized by direct connection, a difference in resonance frequency is, advantageously, unlikely to occur. When power supply (e.g., power supply by capacitive coupling) is realized by electromagnetic field coupling, the band width advantageously increases. In the present embodiment, the planar antenna 10 includes a first strip conductor 13.

The first strip conductor 13 is located between the planar radiation conductor 11 and the ground conductor 12. When viewed in the z-axis direction, the first strip conductor 13 extends in the x direction and partially or entirely overlap the planar radiation conductor 11.

FIG. 3 is an exploded perspective view of the first strip conductor 13. In the present embodiment, the first strip conductor 13 includes planar strips 14, 15 and a conductor 16. In the present embodiment, the planar strip 14 has a rectangular shape which is generally equal in length in the x direction and the y direction. The planar strip 15 has a rectangular shape which has a longitudinal dimension in the x direction. When viewed in the z-axis direction, the planar strips 14, 15 have a rectangular shape which has a longitudinal dimension in the x direction. The conductor 16 is located between the planar strip 14 and the planar strip 15 and is connected with part of the planar strip 15 near one longitudinal end.

As shown in FIG. 2, the first strip conductor 13 extending in the x direction includes a first end portion 13a which is supplied with signal power from an external device and a second end portion 13b which is spaced away from the first end portion 13a in the x direction. The distance in the z-axis direction between the second end portion 13b and the planar radiation conductor 11 is smaller than the distance in the z-axis direction between the first end portion 13a and the planar radiation conductor 11. That is, the distance between the first strip conductor 13 and the planar radiation conductor 11 and the distance between the first strip conductor 13 and the ground conductor 12 vary in the longitudinal direction, so that the gradient of the electromagnetic field in the dielectric space between the planar radiation conductor 11 and the ground conductor 12 increases. Thus, a plurality of resonance modes are likely to occur, and a radiated electromagnetic wave has a broader band. Power supply to the first strip conductor 13 will be described below in detail.

The linear antenna 20 is spaced away from the planar antenna 10 in the x-axis direction. The linear antenna 20 includes at least one linear radiation conductor. In the present embodiment, the linear antenna 20 includes a linear radiation conductor 21 and a linear radiation conductor 22. The linear radiation conductor 21 and the linear radiation conductor 22 each have a stripe shape extending in the y direction and are closely aligned in the y direction.

The linear antenna 20 further includes a power supply conductor 23 and a power supply conductor 24 for supplying signal power to the linear radiation conductor 21 and the linear radiation conductor 22. The power supply conductor 23 and the power supply conductor 24 each have a stripe shape extending in the x direction. One end of the power supply conductor 23 and one end of the power supply conductor 24 are respectively connected with adjoining ends of the aligned linear radiation conductor 21 and linear radiation conductor 22.

When viewed in the z-axis direction, the linear radiation conductor 21 and the linear radiation conductor 22 of the linear antenna 20 may overlap, or may not overlap, the ground conductor 12. When viewed in the z-axis direction, if the linear radiation conductors 21, 22 of the linear antenna 20 do not overlap the ground conductor 12, it is preferred that the linear radiation conductors 21, 22 of the linear antenna 20 are spaced away in the x-axis direction from the edge of the ground conductor 12 by λ/8 or more. When viewed in the z-axis direction, if the linear radiation conductors 21, 22 of the linear antenna 20 overlap the ground conductor 12, it is preferred that the ground conductor 12 and the linear radiation conductors 21, 22 are spaced away in the z-axis direction by λ/8 or more.

Part of the linear antenna 20 including the other ends of the power supply conductor 23 and the power supply conductor 24 may overlap the ground conductor 12 when viewed in the z-axis direction. One of the other ends of the power supply conductor 23 and the power supply conductor 24 is coupled with the reference potential, and the other one is supplied with signal power. The length in the y direction of the linear radiation conductor 21 and the linear radiation conductor 22 is, for example, about 1.2 mm. The length in the x direction (width) of the linear radiation conductor 21 and the linear radiation conductor 22 is, for example, about 0.2 mm.

Next, power supply to the planar antenna 10 and the linear antenna 20 is described. Power supply to the first strip conductor 13 of the planar antenna 10 and the linear radiation conductor 21 of the linear antenna 20 can also be realized by connection via a conductor or by electromagnetic field coupling via a strip conductor, slot power supply, etc.

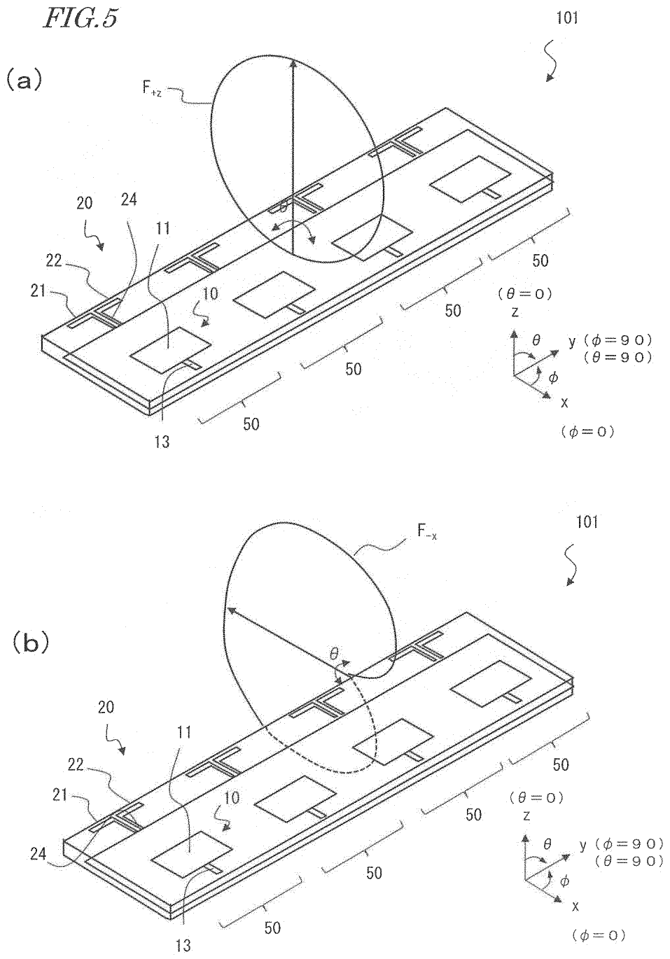

For example, as shown in FIG. 4(a), the ground conductor 12 may have a hole 12c. One end of an electrical conductor 41 provided in the hole 12c may be connected with the planar strip 15 that is a constituent of the first strip conductor 13 of the planar antenna 10. The other end of the electrical conductor 41 is connected with, for example, a circuit pattern (not shown) provided under the ground conductor 12.

Likewise, as shown in FIG. 4(b), the ground conductor 12 may have a hole 12d. One end of an electrical conductor 42 provided in the hole 12d may be connected with one of the power supply conductor 23 and the power supply conductor 24 of the linear antenna 20. FIG. 4(b) shows an example where the power supply conductor 24 is connected with the electrical conductor 42. The other end of the electrical conductor 42 is connected with, for example, a circuit pattern provided under the ground conductor 12. The other one of the power supply conductor 23 and the power supply conductor 24 is connected with the reference potential. As shown in FIG. 4(c), for example, the ground conductor 12 and the power supply conductor 23 may be coupled via an electrical conductor 43.

Next, the arrangement of the planar antenna 10 and the linear antenna 20 in the dielectric 40 is described. As previously described, the planar antenna 10 and the linear antenna 20 are provided in the dielectric 40. As shown in FIG. 1(a), the dielectric 40 has, for example, the shape of a rectangular parallelepiped which has a major surface 40a, a major surface 40b, and lateral surfaces 40c, 40d, 40e, 40f. The major surface 40a and the major surface 40b are two of the six faces of the rectangular parallelepiped which are greater than the other faces. The major surface 40a and the major surface 40b are parallel to the planar radiation conductor 11 and the ground conductor 12. The antenna units 50 are aligned in the y-axis direction as previously described. The alignment pitch in the y direction of the plurality of antenna units 50 is about λ/2.

As shown in FIG. 2, in each of the antenna units 50, the ground conductor 12 of the planar antenna 10 is provided in the dielectric 40. The planar radiation conductor 11 of the planar antenna 10 and the linear radiation conductors 21, 22 of the linear antenna 20 are provided at the major surface 40a of the dielectric 40 or inside the dielectric 40. The planar radiation conductor 11 and the linear radiation conductors 21, 22 are elements which are capable of emitting electromagnetic waves, and therefore, from the viewpoint of improving the radiation efficiency, it is preferred that the planar radiation conductor 11 and the linear radiation conductors 21, 22 are provided on the major surface 40a. However, if the planar radiation conductor 11 and the linear radiation conductors 21, 22 are exposed at the major surface 40a, there is a probability that these conductors will be deformed due to external force or the like, or exposed to external environments so that oxidation or corrosion can occur in the planar radiation conductor 11 and the linear radiation conductors 21, 22. According to research conducted by the present inventors, it was found that if the thickness of the dielectric that covers the planar radiation conductor 11 and the linear radiation conductors 21, 22 is not more than 70 μm, the planar radiation conductor 11 and the linear radiation conductors 21, 22 can be formed at the major surface 40a, and furthermore, the realized radiation efficiency can be equal to or greater than that achieved when an Au/Ni plating layer is formed as the protection film. As the thickness t of part 40h of the dielectric 40 covering the planar radiation conductor 11 and the linear radiation conductors 21, 22 decreases, the loss is smaller. Therefore, the lower limit is not particularly determined from the viewpoint of the antenna characteristics. However, if the thickness t is excessively small, some formation methods of the dielectric 40 can make it difficult to keep the thickness t uniform. For example, to realize the dielectric 40 by a multilayer ceramic structure, for example, the thickness t is preferably not less than 5 μm. That is, more preferably, the thickness t is not less than 5 μm and not more than 70 μm. To achieve a radiation efficiency equal to or greater than that achieved with an Au/Ni-plated planar antenna even when a ceramic material used for the dielectric 40 has low relative permittivity of about 5 to 10, it is preferred that the thickness t is not less than 5 μm and less than 20 μm.

The linear radiation conductors 21, 22 are preferably adjacent to the major surface 40a and close to the lateral surface 40c or 40d that is perpendicular to the x axis. This is because, as will be described later, in order that the linear antenna 20 emits electromagnetic waves in the −x axis direction, the thickness of the dielectric 40 that covers the linear radiation conductors 21, 22 in the x-axis direction is preferably small.

For the foregoing reasons, the distance d in the x-axis direction between the lateral surface 40c and the linear radiation conductors 21, 22 is preferably not more than 70 μm, more preferably not less than 5 μm and not more than 70 μm.

As will be described later, when the multiaxial antenna 101 is realized by a low temperature co-fired ceramic substrate, there is a risk of chipping in the steps of dicing, grooving before baking (half cutting), scribing after baking, isolation by braking. Thus, in some cases, the distance is preferably not less than 150 μm in directions toward the lateral surfaces 40c, 40d, 40e, 40f.

The dielectric 40 may be a resin, glass, ceramic material, or the like, which has the relative permittivity of about 1.5 to 100. Preferably, the dielectric 40 may be a multilayer dielectric structure consisting of a plurality of layers which are made of a resin, glass, ceramic material, or the like. The dielectric 40 is, for example, a multilayer ceramic structure which includes a plurality of ceramic layers. The linear radiation conductors 21, 22, the power supply conductors 23, 24, the planar radiation conductor 11, the ground conductor 12 and the planar strips 14, 15 are provided between the plurality of ceramic layers, and the conductor 16 is provided as a via conductor in one or more ceramic layers. The linear radiation conductors 21, 22, the power supply conductors 23, 24 and the planar radiation conductor 11 may be provided in the same space between the ceramic layers. The linear radiation conductor 21 and the power supply conductor 23, and the linear radiation conductor 22 and the power supply conductor 24 may be in the form of an integral L-shape conductor. The interval in the z-axis direction between the respective components in the planar antenna 10 and the linear antenna 20, such as the interval between the planar radiation conductor 11 and the ground conductor 12, can be adjusted by changing the thickness and number of ceramic layers provided between the respective components.

The respective components of the planar antenna 10 and the linear antenna 20 are made of a material which has electrical conductivity. For example, the components are made of a material which contains a metal, such as Au, Ag, Cu, Ni, Al, Mo, W, or the like.

The multiaxial antenna 101 can be manufactured with the dielectric of the above-described materials and the electrically-conductive materials using known techniques. Particularly, the multiaxial antenna 101 can be suitably manufactured using multilayer (layered) substrate techniques with a resin, glass, ceramic material. For example, when a multilayer ceramic structure is used for the dielectric 40, the multiaxial antenna 101 can be suitably manufactured using the co-fired ceramic substrate techniques. In other words, the multiaxial antenna 101 can be manufactured as a co-fired ceramic substrate.

The co-fired ceramic substrate that forms the multiaxial antenna 101 may be a low temperature co-fired ceramic (LTCC) substrate or may be a high temperature co-fired ceramic (HTCC) substrate. From the viewpoint of high frequency characteristics, using a low temperature co-fired ceramic substrate can be preferred. The ceramic materials and electrically-conductive materials which are used for the dielectric 40, the linear radiation conductors 21, 22, the power supply conductors 23, 24, the planar radiation conductor 11, the ground conductor 12, the planar strips 14, 15 and the conductor 16 are selected according to the firing temperature, uses, and the frequency of wireless communication. An electrically-conductive paste for formation of these components and green sheets for formation of the multilayer ceramic structure of the dielectric 40 are simultaneously fired (co-fired). When the co-fired ceramic substrate is a low temperature co-fired ceramic substrate, a ceramic material and an electrically-conductive material which can be sintered in a temperature range of about 800° C. to about 1000° C. are used. For example, a ceramic material which contains Al, Si and Sr as major constituents and Ti, Bi, Cu, Mn, Na and K as minor constituents, a ceramic material which contains Al, Si and Sr as major constituents and Ca, Pb, Na and K as minor constituents, a ceramic material which contains Al, Mg, Si and Gd, and a ceramic material which contains Al, Si, Zr and Mg can be used. An electrically-conductive material which contains Ag or Cu can be used. The dielectric constant of the ceramic material is about 3 to 15. When the co-fired ceramic substrate is a high temperature co-fired ceramic substrate, a ceramic material which contains Al as a major constituent and an electrically-conductive material which contains W (tungsten) or Mo (molybdenum) can be used.

More specifically, various materials can be used as the LTCC material. For example, an Al—Mg—Si—Gd—O based dielectric material of a low dielectric constant (relative permittivity: 5 to 10), a dielectric material consisting of a Mg₂SiO₄ crystalline phase and Si—Ba—La—B—O based glass, an Al—Si—Sr—O based dielectric material, an Al—Si—Ba—O based dielectric material, and a Bi—Ca—Nb—O based dielectric material of a high dielectric constant (relative permittivity: 50 or higher) can be used.

For example, when the Al—Si—Sr—O based dielectric material contains oxides of Al, Si, Sr and Ti as major constituents and the major constituents, Al, Si, Sr and Ti, are converted to Al₂O₃, SiO₂, SrO and TiO₂, the Al—Si—Sr—O based dielectric material preferably contains Al₂O₃: 10 to 60 mass %, SiO₂: 25 to 60 mass %, SrO: 7.5 to 50 mass %, and TiO₂: not more than 20 mass % (including 0). The Al—Si—Sr—O based dielectric material preferably further contains at least one of the group consisting of Bi, Na, K and Co as a minor constituent in the range of 0.1 to 10 parts by mass when converted to Bi₂O₃, 0.1 to 5 parts by mass when converted to Na₂O, 0.1 to 5 parts by mass when converted to K₂O, 0.1 to 5 parts by mass when converted to CoO, with respect to 100 parts by mass of the major constituents. The Al—Si—Sr—O based dielectric material preferably further contains at least one of the group consisting of Cu, Mn and Ag in the range of 0.01 to 5 parts by mass when converted to CuO, 0.01 to 5 parts by mass when converted to Mn₃O₄, and Ag in the range of 0.01 to 5 parts by mass. In addition, the Al—Si—Sr—O based dielectric material can contain unavoidable impurities.

The operation of the multiaxial antenna 101 is described with reference to FIG. 5(a) and FIG. 5(b). In the multiaxial antenna 101, if signal power is supplied to the planar antenna 10 of each of the antenna units 50 via the first strip conductor 13, as shown in FIG. 5(a), the planar radiation conductor 11 of each of the antenna units 50, as a whole, emits an electromagnetic wave which has the maximum intensity in a direction perpendicular to the planar radiation conductor 11, i.e., the positive direction of the z axis, and which has an intensity distribution F_{+z} spreading over the xz plane that is parallel to the extending direction of the first strip conductor 13. On the other hand, as shown in FIG. 5(b), if signal power is supplied to the linear antenna 20 of each of the antenna units 50, the linear radiation conductors 21, 22, as a whole, emit an electromagnetic wave which has the maximum intensity in the negative direction of the x axis and which has an intensity distribution F₋ₓ spreading over the xz plane.

In the multiaxial antenna 101, the planar antenna 10 and the linear antenna 20 may be concurrently used or may be selectively used. In the case where the gain unfavorably decreases due to interference by concurrently supplying power to these antennas, e.g., in the case where signal power of the same phase is supplied to the planar antenna 10 and the linear antenna 20, a signal to be transmitted/received may be selectively input to the planar antenna 10 or the linear antenna 20 using an RF switch or the like.

When the planar antenna 10 and the linear antenna 20 are concurrently used, it is preferred that the signals input to the planar antenna 10 and the linear antenna 20 have a phase difference. In this case, the interference is suppressed, and the gain can improve. For example, a signal to be transmitted/received may be selectively input to the planar antenna 10 or the linear antenna 20 using, for example, a phase shifter which is formed by a diode switch, a MEMS switch, etc.

The multiaxial antenna 101 includes a plurality of antenna units 50. Therefore, in each of the antenna units 50, one of the planar antenna 10 and the linear antenna 20 is selected, and signal power of the same phase is supplied to the selected antenna, whereby the directivity can be improved as compared with the intensity distribution achieved by a single antenna unit 50. By appropriately shifting the phase of the signal power supplied to the planar antenna 10 or the linear antenna 20 of each of the antenna units 50 such that the planar antenna 10 or the linear antenna 20 has a phase difference among the antenna units 50, or by providing a phase difference between the planar antenna 10 and the linear antenna 20 in each of the antenna units 50 and when necessary varying that phase difference among the antenna units 50, the direction in which the maximum intensity occurs can be changed to the θ direction in the xz plane (φ=0 degree) and the θ direction in the yz plane (φ=90 degrees). Thus, by including a plurality of antenna units 50 and arranging the antenna units 50 in an array, the direction of high directivity can be changed in the xz plane and the yz plane.

As described above, the multiaxial antenna 101 of the present disclosure is capable of radiating electromagnetic waves in two directions which are orthogonal to each other and is capable of receiving electromagnetic waves from the two orthogonal directions.

Various modifications can be made to the multiaxial antenna of the present disclosure. The multiaxial antenna 102 shown in FIG. 6 is different from the multiaxial antenna 101 in that the linear antenna includes a single linear radiation conductor. Each of the antenna units 50 of the multiaxial antenna 102 includes a planar antenna 10 and a linear antenna 26. The planar antenna 10 has the same configuration as the planar antenna of the multiaxial antenna 101.

The linear antenna 26 includes a single linear antenna as described above. In the present embodiment, the linear antenna 26 includes a linear radiation conductor 22 and a power supply conductor 24 connected with the linear radiation conductor 22. The linear radiation conductor 22 and the power supply conductor 24 have the same configuration as corresponding components of the multiaxial antenna 101, and signal power is supplied to the power supply conductor 24.

The linear antenna 26 is a monopole antenna. When signal power is supplied to the linear antenna 26, the linear radiation conductor 22 emits an electromagnetic wave which has the maximum intensity in the negative direction of the x axis and which has an intensity distribution spreading over the xz plane. Therefore, as is the multiaxial antenna 101, the multiaxial antenna 102 is also capable of selectively radiating electromagnetic waves in two orthogonal directions and selectively receiving electromagnetic waves from the two orthogonal directions.

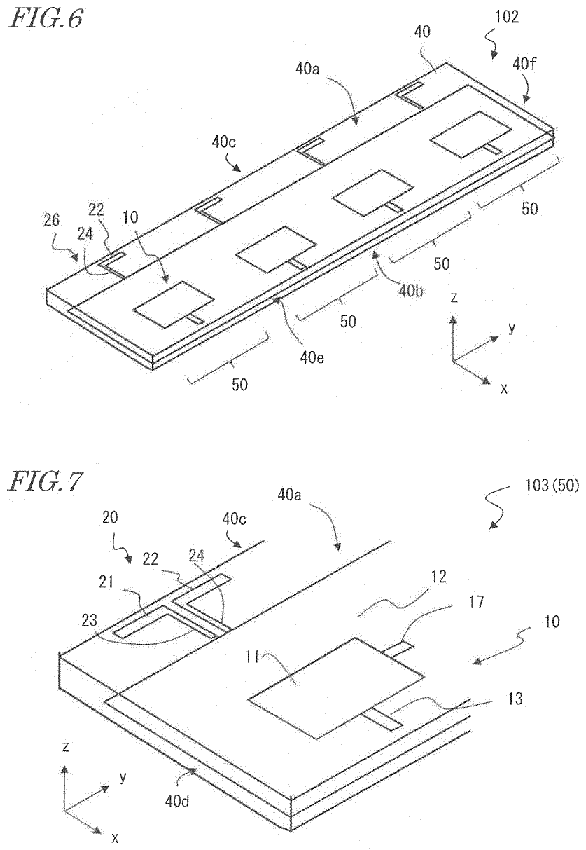

A multiaxial antenna 103 shown in FIG. 7 is different from the multiaxial antenna 101 in that the planar antenna includes two strip conductors for power supply. In the multiaxial antenna 103, the planar antenna 10 of each of the antenna units 50 includes a planar radiation conductor 11, a ground conductor 12, a first strip conductor 13 and a second strip conductor 17.

The shape and arrangement of the planar radiation conductor 11, the ground conductor 12 and the first strip conductor 13 are the same as those of corresponding components of the multiaxial antenna 101. The second strip conductor 17 extends along the y axis. The second strip conductor 17 includes planar strips 14, 15 and a conductor 16 as shown in FIG. 3 as does the first strip conductor 13. Also in the second strip conductor 17, the distance in the third axis direction between the second end portion 13b and the planar radiation conductor 11 is smaller than the distance in the third axis direction between the first end portion 13a and the planar radiation conductor 11. In the y-axis direction, the first end portion 13a is located on the positive side relative to the second end portion 12b.

In the planar antenna 10, the first strip conductor 13 and the second strip conductor 17 may be concurrently used, or either one may be selectively used.

When signal power is supplied to the second strip conductor 17, the planar radiation conductor 11 emits an electromagnetic wave which has the maximum intensity in the positive direction of the z axis and which has an intensity distribution spreading over the yz plane that is parallel to the extending direction of the second strip conductor 17. The direction of the maximum intensity of this electromagnetic wave is identical with that of an electromagnetic wave which is produced when power is supplied to the first strip conductor 13 (the positive direction of the z axis), and the distribution of this electromagnetic wave is generally perpendicular to the distribution of the electromagnetic wave which is produced when power is supplied to the first strip conductor 13. Therefore, according to the multiaxial antenna 103, in addition to switching of the radiation characteristics by switching between the planar antenna 10 and the linear antenna 20, the planar antenna 10 can also switch the two radiation characteristics. Thus, transmission and reception of electromagnetic waves can be selectively performed in a broader azimuthal range.

When concurrently used for the first strip conductor 13 and the second strip conductor 17, the planar antenna 10 performs transmission and reception of electromagnetic waves which have orthogonal polarization planes. Two electromagnetic waves which have orthogonal polarization planes have small interference, and can have high quality when transmitted and received. Thus, the transfer rate of the planar antenna 10 is doubled so that high-speed/large-capacity communication is possible.

Although the planar antenna 10 of the multiaxial antenna 103 includes two strip conductors, it may further include another strip conductor. For example, the planar antenna 10 may further include, in addition to the first strip conductor 13 and the second strip conductor 17, the third strip conductor which extends parallel to the y-axis direction and in which, in the y-axis direction, the first end portion 13a is located on the negative side relative to the second end portion 12b. Due to this component, a radiation characteristic can be further achieved which is different from that achieved by supplying power to the second strip conductor 17.

The multiaxial antenna 104 shown in FIG. 8 is different from the multiaxial antenna 103 in that the multiaxial antenna 104 further includes another linear antenna 27. Each of the antenna units 50 of the multiaxial antenna 104 includes a planar antenna 10, a linear antenna 20 and a linear antenna 27. The configuration of the linear antenna 27 is the same as that of the linear antenna 20 except that the linear radiation conductors 21, 22 are located close to the lateral surface 40e. The linear antenna 20 and the linear antenna 27 are aligned in the x-axis direction with the planar antenna 10 interposed therebetween.

The radiation characteristic of the linear antenna 27 is equal to the 180-degree rotation about the Z axis of the radiation characteristic of the linear antenna 20. Due to inclusion of the linear antenna 27, the multiaxial antenna 104 can further have the radiation characteristic in the +x direction, and transmission and reception of electromagnetic waves are possible in a broader azimuthal range.

### Second Embodiment

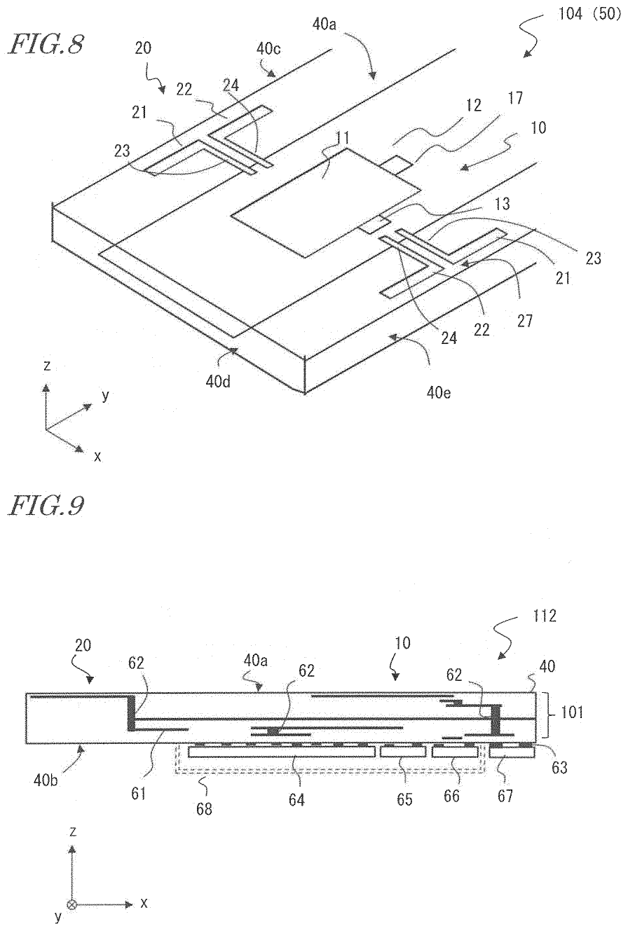

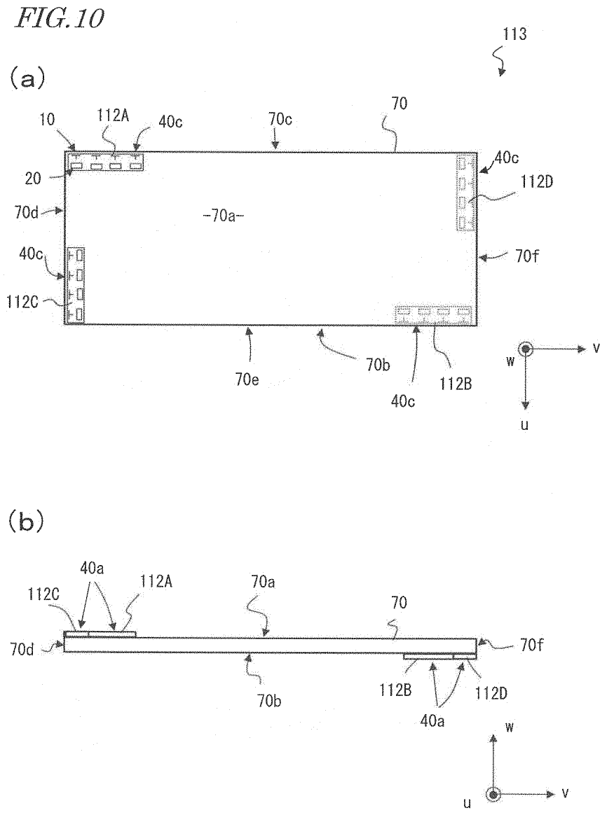

An embodiment of the wireless communication module of the present disclosure is described. FIG. 9 is a schematic cross-sectional view of a wireless communication module 112. The wireless communication module 112 includes the multiaxial antenna 101 of the first embodiment, active elements 64, 65, a passive element 66, and a connector 67. The wireless communication module 112 may include a cover 68 which covers the active elements 64, 65 and the passive element 66. The cover 68 is made of a metal or the like and has at least one of an electromagnetic shield function and a heat sink function. When the heat radiation function is not necessary, the active elements 64, 65 and the passive element 66 may be overmolded with a resin instead of the cover 68.

In part of the dielectric 40 of the multiaxial antenna 101 which is on the major surface 40b side relative to the ground conductor 12, a conductor 61 and a via conductor 62 are provided which form a wiring circuit pattern for connection with the planar antenna 10 and the linear antenna 20. The planar antenna 10 and the linear antenna 20 and the conductor 61 are connected via the via conductor 62. On the major surface 40b, the electrodes 63 are provided.

The active elements 64, 65 are a DC/DC converter, a low noise amplifier (LNA), a power amplifier (PA), a high frequency IC, or the like. The passive element 66 is a capacitor, a coil, an RF switch, or the like. The connector 67 is a connector for connecting the wireless communication module 112 with an external device.

The active elements 64, 65, the passive element 66 and the connector 67 are connected by soldering or the like with the electrodes 63 on the major surface 40b of the dielectric 40 of the multiaxial antenna 101, whereby the active elements 64, 65, the passive element 66 and the connector 67 are mounted to the major surface 40b of the multiaxial antenna 101. The wiring circuit formed by the conductor 61 and the via conductor 62, the active elements 64, 65, the passive element 66 and the connector 67 form a signal processing circuit or the like.

In the wireless communication module 112, the major surface 40a that is close to the planar antenna 10 and the linear antenna 20 is located opposite to the major surface 40b on which the active elements 64, 65 and other elements are connected. Therefore, the planar antenna 10 and the linear antenna 20 are capable of radiating electromagnetic waves and receiving electric waves in the quasi-millimeter wave band and the millimeter wave band from external devices without being affected by the active elements 64, 65 and other elements. Thus, a small-size wireless communication module can be realized which has an antenna that is capable of selectively transmitting and receiving electromagnetic waves in two orthogonal directions.

### Third Embodiment

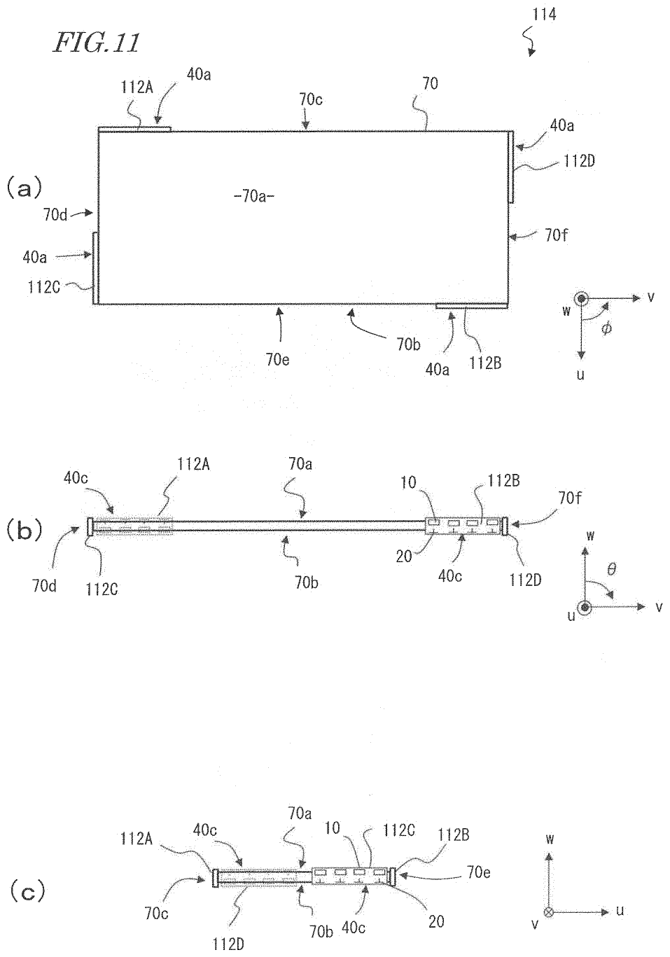

An embodiment of the wireless communication device of the present disclosure is described. FIG. 10(a) and FIG. 10(b) are a schematic plan view and side view of the wireless communication device 113. The wireless communication device 113 includes a main board (circuit board) 70 and one or a plurality of wireless communication modules 112. In FIG. 10, the wireless communication device 113 includes four wireless communication modules 112A to 112D.

The main board 70 includes an electronic circuit required for realizing the function of the wireless communication device 113, a wireless communication circuit, and other elements. For the purpose of detecting the attitude and position of the main board 70, the main board 70 may include a geomagnetic sensor, a GPS unit, or the like.

The main board 70 has major surfaces 70a, 70b and four lateral portions 70c, 70d, 70e, 70f. The major surfaces 70a, 70b are perpendicular to the w axis of the second right-handed Cartesian coordinate system. The lateral portions 70c, 70e are perpendicular to the u axis. The lateral portions 70d, 70f are perpendicular to the v axis. In FIG. 10, the main board 70 is schematically shown as being a rectangular parallelepiped which has rectangular major surfaces, although each of the lateral portions 70c, 70d, 70e, 70f may be formed by a plurality of faces.

The wireless communication device includes one or a plurality of wireless communication modules. The number of wireless communication modules can be adjusted according to the specifications and required performance of the wireless communication device, for example, in which azimuth transmission and reception of electromagnetic waves are to be performed, how high the sensitivity for transmission and reception is to be, etc. The location of the wireless communication modules in the main board 70 can be determined at arbitrary positions in consideration of electromagnetic interference with other wireless communication modules and other function modules in the wireless communication device, interference in arrangement, and the sensitivity in transmission and reception of electromagnetic waves in the case where the wireless communication device is covered by a case. When the wireless communication modules are placed on the major surfaces 70a, 70b of the main board 70, the wireless communication module at positions close to one of the lateral portions 70c, 70d, 70e, 70f are, in some cases, unlikely to undergo interference with other circuits provided in the main board 70 can be avoided. However, the location of the wireless communication modules on the major surfaces 70a, 70b is not limited to positions close to the lateral portions 70c, 70d, 70e, 70f but may be in the central part of the major surfaces 70a, 70b.

In the present embodiment, in the wireless communication device 113, the wireless communication modules 112A to 112D are located on the major surface 70a or the major surface 70b such that the lateral surface 40c of the dielectric 40 of the multiaxial antenna 101 is close to one of the lateral portions 70c, 70d, 70e, 70f and that the major surface 40a of the dielectric 40 is located opposite to the main board 70. The lateral surface 40c of the dielectric 40 is close to the linear radiation conductors 21, 22 of the linear antenna 20, and electromagnetic waves are radiated from the lateral surface 40c. The major surface 40a of the dielectric 40 is close to the planar radiation conductor 11 of the planar antenna 10, and electromagnetic waves are radiated from the major surface 40a. Therefore, the wireless communication modules 112A to 112D are located on the main board 70 at a position and a direction such that electromagnetic waves radiated from the wireless communication modules 112A to 112D are unlikely to interfere with the main board 70. The wireless communication modules 112A to 112D may be close to one another, or may be away from one another, in the u, v and w directions.

For example, in the example shown in FIG. 10, the wireless communication modules 112A, 112C are located on the major surface 70a such that the lateral surface 40c of the wireless communication modules 112A, 112C is close to either of the lateral portions 70c, 70d. The wireless communication module 112B, 112D are located on the major surface 70b such that the lateral surface 40c of the wireless communication module 112B, 112D is close to either of the lateral portions 70e, 70f. In the present embodiment, the lateral surface 40c of the wireless communication module 112A is close to the lateral portion 70c, and the lateral surface 40c of the wireless communication module 112B is close to the lateral portion 70e. The lateral surface 40c of the wireless communication module 112C is close to the lateral portion 70d, and the lateral surface 40c of the wireless communication module 112D is close to the lateral portion 70f. The wireless communication modules 112A to 112D are arranged in point symmetry about the center of the main board 70.

In the distribution of electromagnetic waves radiated from the planar antenna 10 and the linear antenna 20 of the thus-located wireless communication modules 112A to 112D, the direction of the maximum intensity is as shown in TABLE 1.

TABLE 1

| | RADIATION | RADIATION |
|---|---|---|
| WIRELESS | DIRECTION | DIRECTION |
| COMMUNICATION | OF PLANAR | OF LINEAR |
| MODULE | ANTENNA 10 | ANTENNA |
| 112A | +w | −u |
| 112B | −w | +u |
| 112C | +w | −v |
| 112D | −w | +v |

Thus, electromagnetic waves can be radiated in all azimuths (±u, ±v, ±w directions) with respect to the main board 70. For example, when the position is detected by the GPS unit of the wireless communication device 113, the closest one of a plurality of base stations which are around the wireless communication device 113 and whose positional information are known and the azimuth from the wireless communication device 113 of that base station can be determined. When the geomagnetic sensor of the wireless communication device 113 is used, the attitude of the wireless communication device 113 can be determined, and one of the wireless communication modules 112A to 112D and one of the planar antenna 10/the linear antenna 20 which can radiate electromagnetic waves at the maximum intensity to the determined base station to communicate with in consideration of the current attitude of the wireless communication device 113 can be determined. Thus, by performing transmission and reception of electromagnetic waves using the determined wireless communication module and antenna, high-quality communication can be performed.

The wireless communication modules 112A to 112D may be located on a lateral portion of the main board 70. FIG. 11(a), FIG. 11(b) and FIG. 11(c) are a schematic plan view and side views of a wireless communication device 114. In the wireless communication device 114, the wireless communication modules 112A to 112D are located on any of the lateral portions 70c to 70f such that the lateral surface 40c of the dielectric 40 of the multiaxial antenna 101 is close to the major surface 70a or the major surface 70b and that the major surface 40a of the dielectric 40 is opposite to the main board 70.

In the example shown in FIG. 11, the wireless communication modules 112A, 112B are located on the lateral portions 70c, 70e such that the lateral surface 40c of the wireless communication modules 112A, 112B is close to either of the major surfaces 70a, 70b. The wireless communication modules 112C, 112D are located on the lateral portions 70d, 70f such that the lateral surface 40c of the wireless communication modules 112C, 112D is close to either of the major surfaces 70a, 70b. In the present embodiment, the lateral surface 40c of the wireless communication module 112A is close to the major surface 70a, and the lateral surface 40c of the wireless communication module 112B is close to the major surface 70b. The lateral surface 40c of the wireless communication module 112C is close to the major surface 70a, and the lateral surface 40c of the wireless communication module 112D is close to the major surface 70b. The wireless communication modules 112A to 112D are arranged in point symmetry about the center of the main board 70. The positions in the w axis direction of the wireless communication modules 112A to 112D may deviate from the center in the w axis direction of the main board 70. The wireless communication modules 112A to 112D may be in contact with, or may be spaced away from, the lateral portions 70c to 70f of the main board 70.

In the distribution of electromagnetic waves radiated from the planar antenna 10 and the linear antenna 20 of the thus-located wireless communication modules 112A to 112D, the direction of the maximum intensity is as shown in TABLE 2.

TABLE 2

| | RADIATION | RADIATION |
|---|---|---|
| WIRELESS | DIRECTION | DIRECTION |
| COMMUNICATION | OF PLANAR | OF LINEAR |
| MODULE | ANTENNA 10 | ANTENNA |
| 112A | −u | +w |
| 112B | +u | −w |
| 112C | −v | −w |
| 112D | +v | +w |

Thus, the arrangement shown in FIG. 11 also enables the wireless communication device 114 to radiate electromagnetic waves in all azimuths (±u, ±v, ±w directions) with respect to the main board 70.

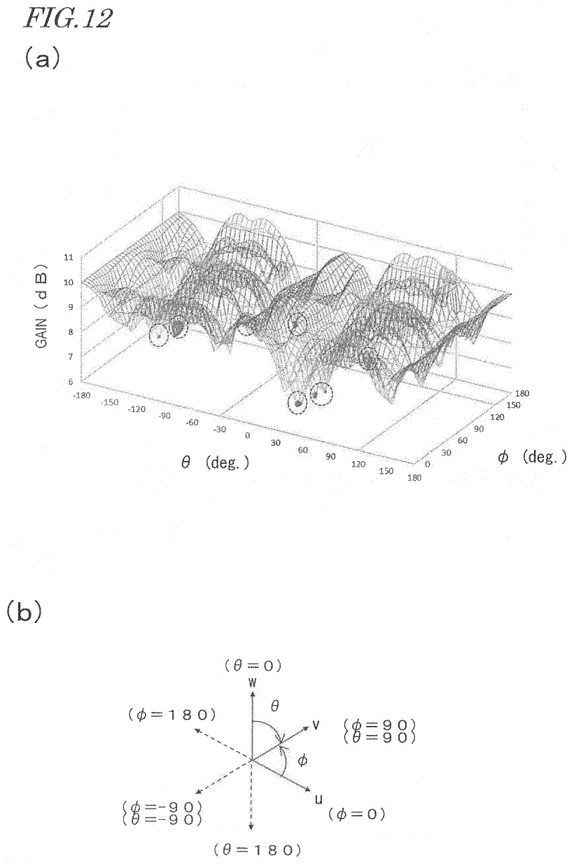

FIG. 12(a) shows an example of the intensity distribution of electromagnetic waves radiated from the wireless communication device 114 that includes four wireless communication modules as shown in FIG. 11, which was determined by simulation. θ that represents the direction of electromagnetic waves represents the angle in the WV plane which positively increases from the w axis in the v-axis direction relative to the w axis as shown in FIG. 11(b) and FIG. 12(b). φ represents the angle in the uv plane which positively increases from the u axis in the v-axis direction relative to the u axis as shown in FIG. 11(a) and FIG. 12(b).

As shown in FIG. 12, the largeness of the gain varies depending on the angles θ and φ, although the achieved gain is not less than 7 dB in almost all the ranges of θ and φ. In FIG. 12, regions where the gain is less than 7 dB are encircled by broken lines and painted colored in black. The black regions are about 0.5% of the entire ranges of θ and φ. That is, the achieved gain is not less than 7 dB in about 99.5% of all the azimuthal range.

The gain distributions shown in FIG. 12 are not concurrently achieved but are achieved when electromagnetic waves are radiated while switching a plurality of multiaxial antennas. As described above, by selecting one of a plurality of multiaxial antennas and selecting one of the linear antenna and the planar antenna, electromagnetic waves of high directivity can be transmitted and received. That is, according to the present embodiment, due to inclusion of a plurality of multiaxial antennas, a wireless communication device can be realized whose azimuthal coverage is wide and which is excellent in directivity.

(Variations)

Various modifications can be made to the multiaxial antenna, the wireless communication module and the wireless communication device of the present disclosure.

[Form in which Planar Antenna and Linear Antenna are Exposed]

In the previously-described embodiment, the radiation conductors of the planar antenna and the linear antenna are covered with a dielectric. However, the radiation conductors may be exposed out of the dielectric. FIG. 13 is a schematic cross-sectional view of a multiaxial antenna 115. For example, as shown in FIG. 13, in the multiaxial antenna 115, the planar radiation conductor 11 of the planar antenna 10, the linear radiation conductors 21, 22 of the linear antenna 20, and the power supply conductors 23, 24 connected with these conductors may be provided on the major surface 40a of the dielectric 40 and exposed out of the dielectric 40. When it is not necessary to protect the planar radiation conductor 11 and the linear radiation conductors 21, 22 with the dielectric, these conductors are exposed out of the dielectric 40, whereby the radiation efficiency of the antennas can be further improved.

[Another Form of Power Supply to Power Supply Conductor]

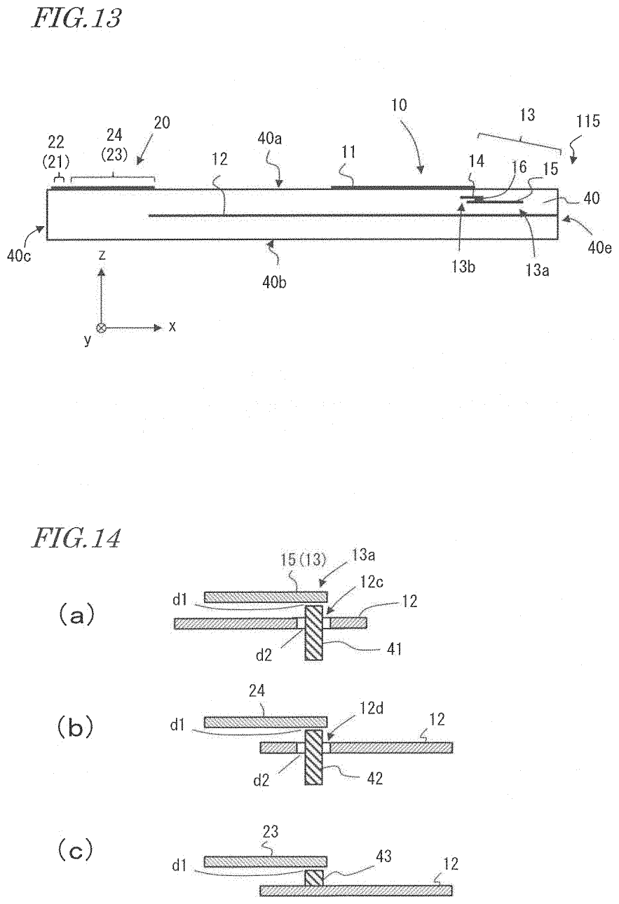

In the first embodiment, supply of the signal power to the power supply conductors 23, 24 and the first strip conductor 13 or coupling with the reference potential are realized by direct connection of conductors. However, they may be coupled by capacitive coupling instead of direct connection with conductors. As shown in FIG. 14(a) to FIG. 14(c), the planar strip 15, power supply elements 23, 24 and electrical conductors 41, 42, 43 are not in contact, but spaces may be formed. The spaces are filled with part of the dielectric 40 or a gas such as air. In this case, to suppress leakage of the signal power to the ground conductor 12, it is preferred that the space distance d1 is smaller than the interval d2 between holes 12c, 12d provided in the ground conductor 12 and the electrical conductors 41, 42.

The capacitance can be adjusted by the largeness of the above-described distance, and the design flexibility in circuit designing of the planar antenna and the linear antenna can be improved.

[Form with Shield]

In a multiaxial antenna, a shield for suppressing propagation of electromagnetic waves or an electromagnetic wave absorbing structure may be provided between antenna units or between the planar antenna and the linear antenna of an antenna unit.

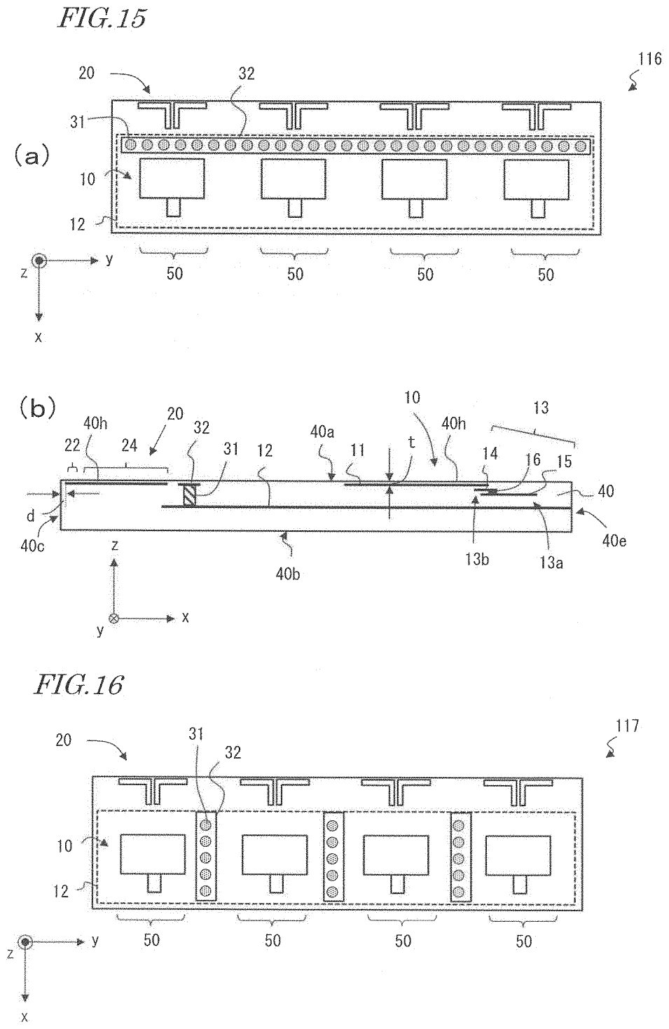

FIG. 15(a) is a schematic top view of a multiaxial antenna 116. FIG. 15(b) is a schematic cross-sectional view of the multiaxial antenna 116 which is perpendicular to the y axis. The multiaxial antenna 116 is different from the multiaxial antenna 101 of the first embodiment in that the multiaxial antenna 116 includes a plurality of via conductors 31 and a conductor 32.

The via conductors 31 have the shape of a pole extending in the z-axis direction. In each of the antenna units 50, the plurality of via conductors 31 are provided on the ground conductor 12 and aligned in the y-axis direction between the planar antenna 10 and the linear antenna 20. One end of the plurality of via conductors 31 is connected with the ground conductor 12, and the other end is connected with the conductor 32. The via conductors 31 can be formed by, for example, forming through holes in ceramic green sheets which are to be used in formation of the dielectric 40, filling the through holes with an electrically-conductive paste, and stacking up the ceramic green sheets.

In the multiaxial antenna 116, the via conductors 31 that are connected with the ground conductor 12 are located between the planar antenna 10 and the linear antenna 20. Thus, mutual interference of electromagnetic waves between the planar antenna 10 and the linear antenna 20 can be suppressed.

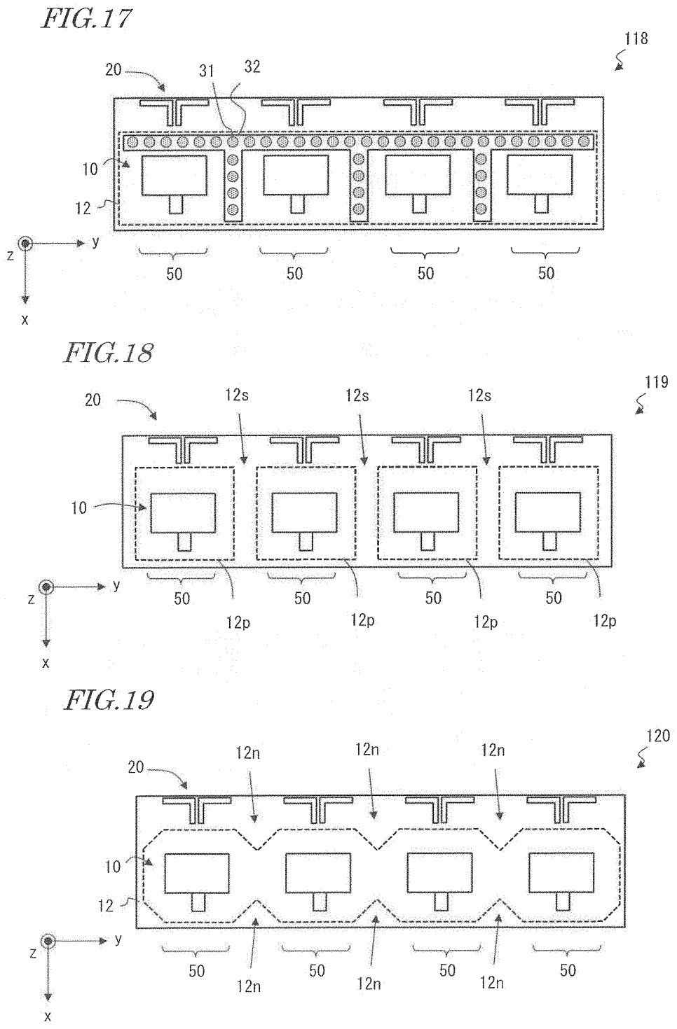

The arrangement of the via conductors 31 is not limited to the example shown in FIG. 15. FIG. 16 and FIG. 17 are schematic top view of multiaxial antennas, showing other arrangement examples of the via conductors. In the multiaxial antenna 117 shown in FIG. 16, the via conductors 31 are provided between the antenna units 50. In the multiaxial antenna 118 shown in FIG. 17, the via conductors 31 are provided between the antenna units 50 and between the planar antenna 10 and the linear antenna 20 in each of the antenna units 50. Also in these forms, electromagnetic interaction between two regions separated by the via conductors 31 can be suppressed.

[Other Forms of Ground Conductor]

FIG. 18 and FIG. 19 are schematic top views of multiaxial antennas 119, 120 which include ground conductors of other forms. In the multiaxial antenna 101 of the first embodiment, the ground conductors 12 are connected in the y direction. Therefore, when electric power is supplied to the first strip conductor 13 and electromagnetic waves are radiated, the power of the electromagnetic waves can decrease in some cases due to the influence of reflection of the electromagnetic waves propagating through the ground conductor 12 in the y direction. If such decrease of the power is unfavorable, slits 12s may be provided in the ground conductor 12 between adjoining antenna units 50 as shown in FIG. 18 such that the ground conductors 12p of the antenna units 50 are electrically separated.

When the distribution of the electromagnetic waves radiated from the planar antenna 10 is affected by the circumstance that the ground conductors 12 are connected in the y-axis direction, the ground conductors 12 may have notches such that the divergence of the electromagnetic wave can be suppressed. As shown in FIG. 19, the ground conductors 12 may have notches 12n between adjoining antenna units 50. The notches 12n may have the shape of, for example, a right-angled isosceles triangle whose base is parallel to the y axis. By providing the notches 12n, the difference in shape between the x direction and the y direction of the ground conductor 12 in each of the antenna units 50 can be reduced, and the symmetry about the z axis of the combined electromagnetic wave can be improved.

[Other Forms of Arrangement of Antennas, Power Supply Conductors, and Other Elements]

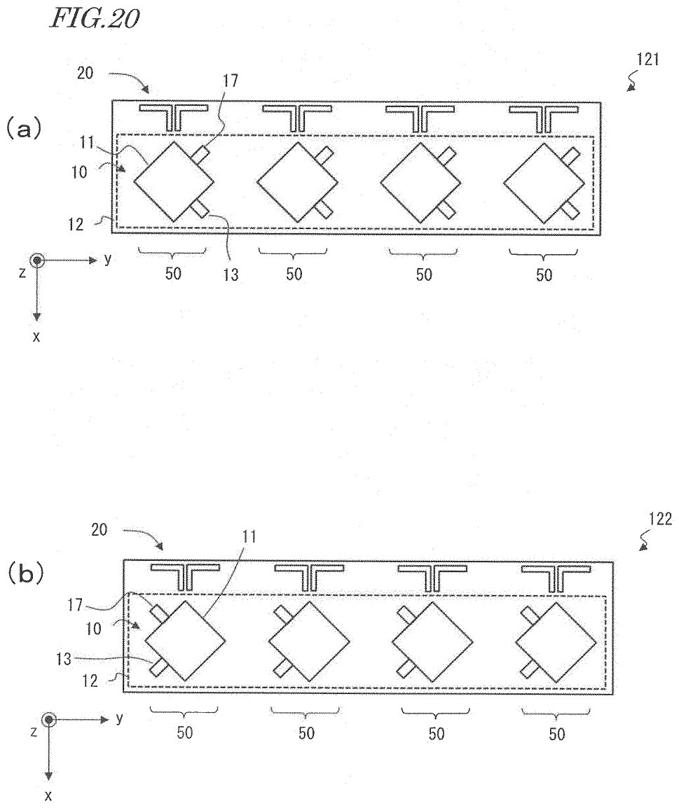

In the multiaxial antenna 103 shown in FIG. 7, the planar antenna 10 includes two strip conductors for power supply (the first strip conductor 13, the second strip conductor 17). The extending directions of the two strip conductors are not limited to those shown in the form of FIG. 7. FIG. 20(a) and FIG. 20(b) and FIG. 21(a) and FIG. 21(b) are schematic top views of multiaxial antennas 121 to 124 among which the form of the planar antenna is different. In the multiaxial antennas 121 to 124, the planar antenna 10 includes a generally-square, planar radiation conductor 11. When viewed in plane, each side of the planar radiation conductor 11 forms an angle of 45° with respect to the x axis and the y axis. The two strip conductors 13, 17 extend in a direction which forms an angle of 45° with respect to the x axis and the y axis. The two strip conductors 13, 17 extend in directions which are orthogonal to each other. By arranging the strip conductors 13, 17 so as to extend in different directions, the traveling directions of electromagnetic waves emitted from the planar antenna 10 and the distribution of the electromagnetic waves can be varied. In the multiaxial antennas 121 to 124, each side of the planar radiation conductor 11 forms an angle of 45° with respect to the x axis and the y axis, although the angle each side of the planar radiation conductor 11 forms with respect to the x axis and the y axis may be different from 45° so long as the two strip conductors 13, 17 are perpendicular to each other.

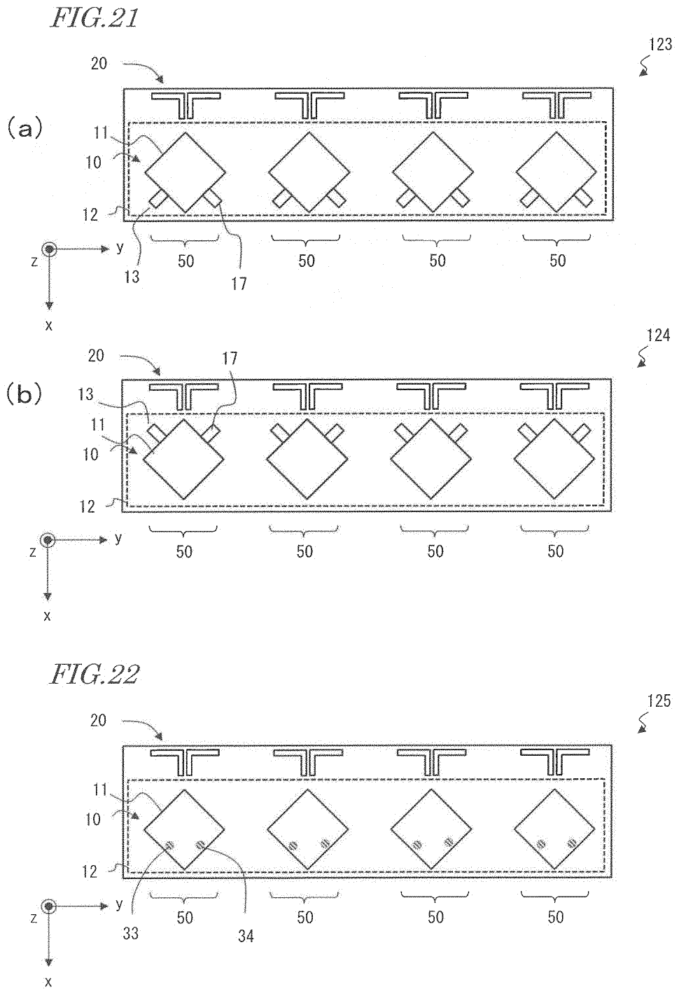

As previously described, power supply to the planar radiation conductor of the planar antenna may be directly realized by connecting a conductor to the planar radiation conductor. FIG. 22 is a schematic top view of a multiaxial antenna 125. In the multiaxial antenna 125, the planar antenna 10 includes via conductors 33, 34 instead of the strip conductors. The via conductors 33, 34 have the shape of a pole extending in the z-axis direction and are connected near the two adjoining sides of the planar radiation conductor 11.

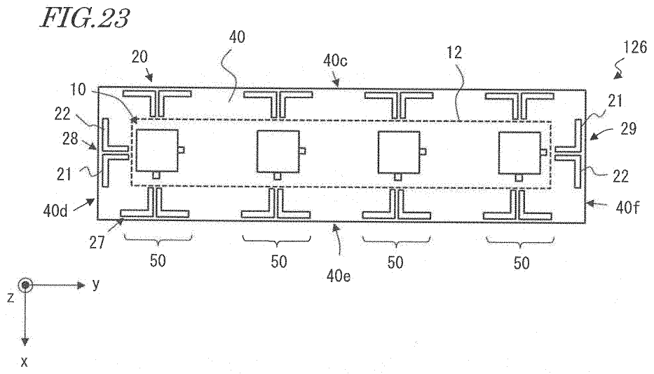

The arrangement and number of linear antennas are not limited to those of the previously-described embodiment. FIG. 23 is a schematic top view of a multiaxial antenna 126. The multiaxial antenna 126 is different from the multiaxial antenna 104 shown in FIG. 8 in that the multiaxial antenna 126 further includes linear antennas 28, 29. Ones of the antenna units 50 of the multiaxial antenna 126 which are adjacent to the lateral surfaces 40d, 40f of the dielectric respectively include linear antennas 28, 29 which are adjacent to the lateral surfaces 40d, 40f. The linear antennas 28, 29 have the same configuration as the linear antenna 20 except that the linear radiation conductors 21, 22 are located adjacent to the lateral surface 40d or the lateral surface 40f. The ground conductor 12 is not provided under the linear antennas 20, 27, 28, 29 but under the planar antenna 10. Due to inclusion of the linear antennas 28, 29, the multiaxial antenna 126 is capable of transmitting and receiving electromagnetic waves over a broader azimuthal range.

[Other Forms of Mounting]

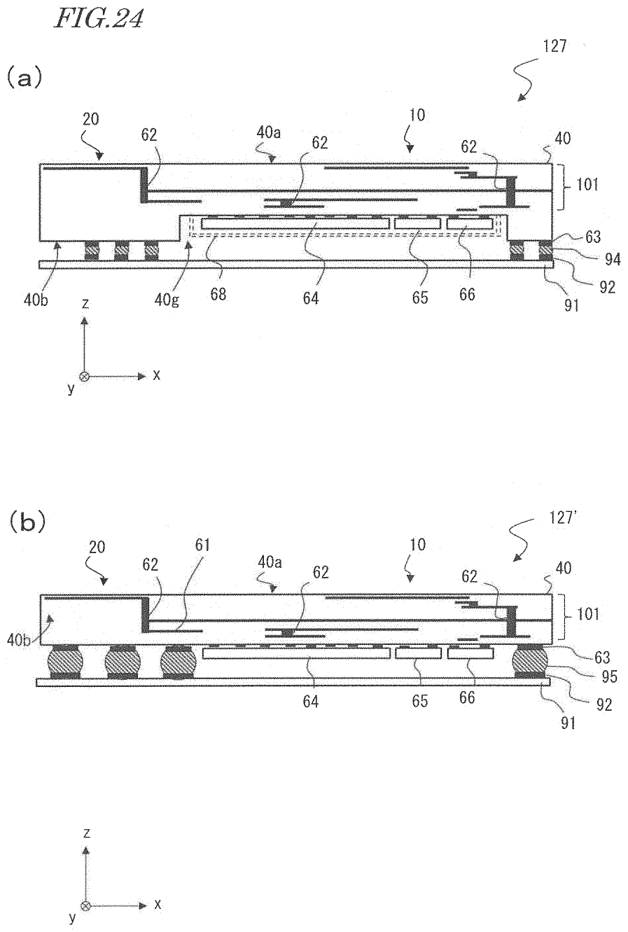

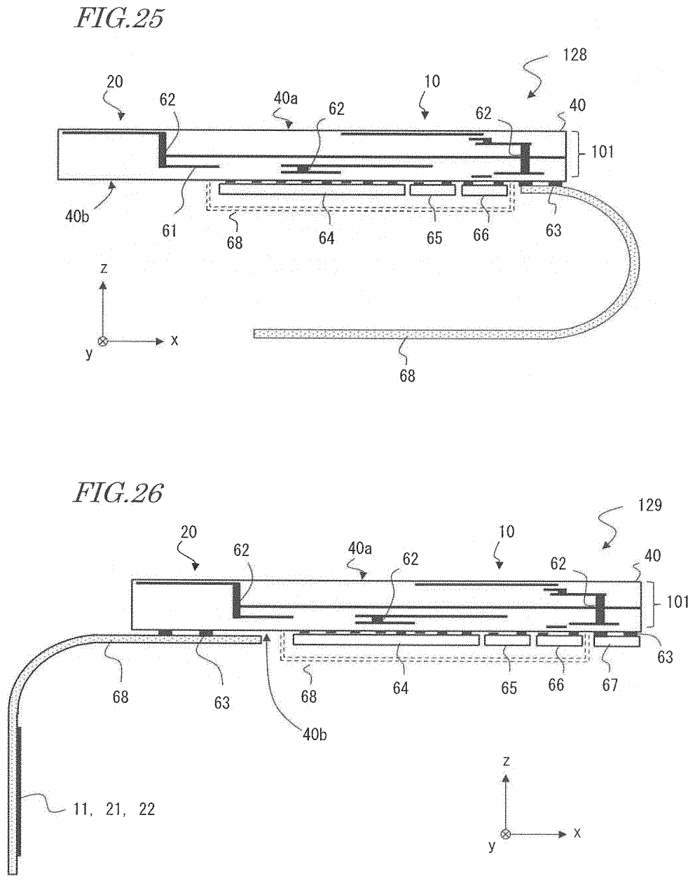

The multiaxial antenna 101 can take various forms when mounted to other substrates and can be used as a module or wireless communication device. FIG. 24 to FIG. 26 are schematic cross-sectional views of wireless communication modules 127 to 129. In the multiaxial antenna 101 of the wireless communication module 127 shown in FIG. 24(a), the major surface 40b of the dielectric 40 has a recessed portion 40g, and active elements 64, 65 and a passive element 66 are provided in the recessed portion 40g. On the major surface 40b, electrodes 63 are provided.

The multiaxial antenna 101 is mounted to a circuit board 91 which has electrodes 92. For example, the electrodes 92 of the circuit board 91 and the electrodes 63 of the multiaxial antenna 101 are joined together by solder bumps 94. The solder bumps 94 can be formed beforehand in the form of a ball grid array on the electrodes 63 or the electrodes 92.

When solder bumps 95 are large as in the wireless communication module 127′ shown in FIG. 24(b), the active elements 64, 65 and the passive element 66 may be provided on the flat major surface 40b without providing a recessed portion in the dielectric 40.

In the wireless communication module 128 shown in FIG. 25, the electrodes 63 of the multiaxial antenna 101 are electrically coupled with a flexible wire 68. The flexible wire 68 is, for example, a flexible printed substrate on which a wiring circuit is provided, a coaxial cable, a liquid crystal polymer substrate, or the like. Particularly, the liquid crystal polymer has excellent high frequency characteristics and therefore can be suitably used as a wiring circuit for the multiaxial antenna 101.

In the wireless communication module 129 shown in FIG. 26, the electrodes 63 of the multiaxial antenna 101 are electrically coupled with a flexible wire 68. On the surface of the flexible wire 68 and/or inside the flexible wire 68, the planar radiation conductor 11, the linear radiation conductors 21, 22 and other elements, which are part of the multiaxial antenna 101, are provided.

In the wireless communication module 129, by bending the flexible wire 68, the planar radiation conductor 11 and the linear radiation conductors 21, 22 that are provided on the flexible wire 68 can be arranged in a different direction from the planar radiation conductor 11 and the linear radiation conductors 21, 22 provided on the dielectric 40. Thus, transmission and reception of electromagnetic waves can be performed over a broader azimuthal range.

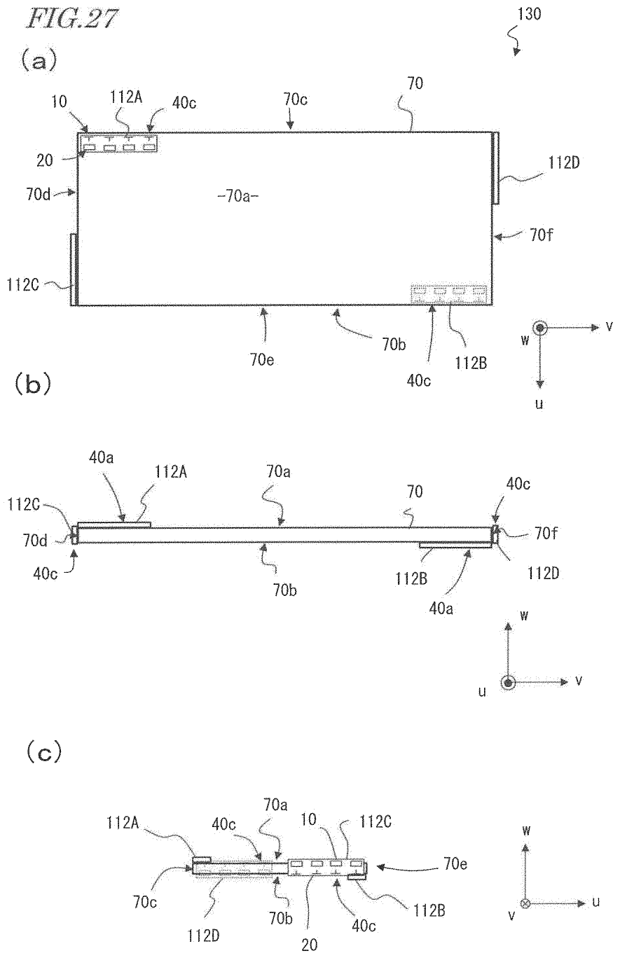

The arrangement of the wireless communication module is not limited to that of the previously-described embodiment. FIG. 27(a), FIG. 27(b) and FIG. 27(c) are a schematic plan view and side views of a wireless communication device 130. In the wireless communication device 130, the wireless communication modules 112A, 112B are respectively provided on the major surfaces 70a, 70b of the main board 70, and the wireless communication modules 112C, 112D are respectively provided on the lateral portions 70d, 70f. That is, the wireless communication modules may be provided on both the major surfaces and the lateral portions of the main board. The number of wireless communication modules provided on the major surfaces and the number of wireless communication modules provided on the lateral portions are each not limited to two, but may be one and three, or may be three and one. The wireless communication device 130 may include one to three wireless communication modules on the major surfaces and the lateral portions. Specifically, at least one of the plurality of wireless communication modules may be provided on any of the major surfaces 70a, 70b of the main board 70 while the other at least one is provided on any of the first to fourth lateral portions 70c to 70f of the main board 70.

In the distribution of electromagnetic waves radiated from the planar antenna 10 and the linear antenna 20 of the wireless communication modules 112A to 112D of the wireless communication device 130, the direction of the maximum intensity is as shown in TABLE 3.

TABLE 3

| | RADIATION | RADIATION |
|---|---|---|
| WIRELESS | DIRECTION | DIRECTION |
| COMMUNICATION | OF PLANAR | OF LINEAR |
| MODULE | ANTENNA 10 | ANTENNA |
| 112A | +w | −u |
| 112B | −w | +u |
| 112C | −v | −w |
| 112D | +v | +w |

### INDUSTRIAL APPLICABILITY

A multiaxial antenna, a wireless communication module and a wireless communication device of the present disclosure can be suitably used for various antennas for high frequency wireless communication and wireless communication circuits which include the antennas, and particularly, suitably used for wireless communication device of bands.

### REFERENCE SIGNS LIST

10 planar antenna
11 planar radiation conductor
12 ground conductor
12b second end portion
12c, 12d hole
13 first strip conductor
13a first end portion
13b second end portion
14, 15 planar strip
16 conductor
17 second strip conductor
20, 26, 27 linear antenna
21, 22 linear radiation conductor
23, 24 power supply conductor
40 dielectric
40a, 40b major surface
40c to 40h lateral surface
40h part
41, 42, 43 electrical conductor
50 antenna unit
61 conductor
62 via conductors
63, 92 electrode
64, 65 active element
66 passive element
67 connector
68 cover
70 main board
70a, 70b major surface
70c to 70f lateral portion
91 circuit board
94, 95 solder bump
101 to 104, 115 to 126 multiaxial antenna
112, 112A to 112D, 127 to 129 wireless communication module
113, 114, 130 wireless communication device

1-28. (canceled)

29. A multiaxial antenna comprising an antenna unit, the antenna unit including
a planar antenna which includes a planar radiation conductor and a ground conductor, the planar radiation conductor and the ground conductor being spaced away from each other in a third axis direction in a first right-handed Cartesian coordinate system which has first, second and third axes, and
at least one linear antenna which is spaced away from the planar antenna in a first axis direction, the linear antenna including one or two linear radiation conductors extending in a second axis direction.

30. The multiaxial antenna of claim 29, wherein the planar antenna further includes a first strip conductor located between the planar radiation conductor and the ground conductor and extending in the first axis direction, part of the first strip conductor overlapping the planar radiation conductor when viewed in the third axis direction.

31. The multiaxial antenna of claim 30, wherein the first strip conductor has a first end portion which is supplied with electric power from an external device and a second end portion which is spaced away from the first end portion in the first axis direction, and a distance in the third axis direction between the second end portion and the planar radiation conductor is smaller than a distance in the third axis direction between the first end portion and the planar radiation conductor.

32. The multiaxial antenna of claim 29, wherein the planar antenna further includes a second strip conductor located between the planar radiation conductor and the ground conductor and extending in the second axis direction, part of the second strip conductor overlapping the planar radiation conductor when viewed in the third axis direction.

33. The multiaxial antenna of claim 32, wherein the second strip conductor has a first end portion which is supplied with electric power from an external device and a second end portion which is spaced away from the first end portion in the second axis direction, and a distance in the third axis direction between the second end portion and the planar radiation conductor is smaller than a distance in the third axis direction between the first end portion and the planar radiation conductor.

34. The multiaxial antenna of claim 29, wherein, when viewed in the third axis direction, the one or two linear radiation conductors do not overlap the ground conductor.

35. The multiaxial antenna of claim 34, wherein, when viewed in the third axis direction, the one or two linear radiation conductors are away from an end portion of the ground conductor in the first axis direction by λ/8 or more where λ is the wavelength of a carrier wave in a frequency band used by the multiaxial antenna.

36. The multiaxial antenna of claim 29, wherein the linear antenna includes a single piece of the linear radiation conductor and further includes a power supply conductor connected with one end of the linear radiation conductor and extending in the first axis direction.

37. The multiaxial antenna of claim 29, wherein
the linear antenna includes two pieces of the linear radiation conductor and further includes two power supply conductors extending in the first axis direction,
the two linear radiation conductors are aligned in the second axis direction,
ends of the two power supply conductors are respectively connected with ends of the two aligned linear radiation conductors which are adjoining each other, and
the other end of one of the two power supply conductors is grounded while the other end of the other power supply conductor is supplied with electric power from an external device.

38. The multiaxial antenna of claim 36, wherein part of the power supply conductor overlaps the ground conductor when viewed in the third axis direction.

39. The multiaxial antenna of claim 29, further comprising a dielectric which has a major surface perpendicular to the third axis direction, at least the ground conductor of the planar antenna being located inside the dielectric.

40. The multiaxial antenna of claim 39, wherein
the dielectric has a lateral surface which is adjacent to the major surface and perpendicular to the first axis, and
the one or two linear radiation conductors of the linear antenna is located close to the lateral surface.

41. The multiaxial antenna of claim 39, wherein the planar radiation conductor of the planar antenna and the one or two linear radiation conductors of the linear antenna are located on the major surface.

42. The multiaxial antenna of claim 39, wherein the planar antenna and the linear antenna are located inside the dielectric.

43. The multiaxial antenna of claim 39, wherein
the dielectric is a multilayer ceramic structure including a plurality of ceramic layers stacked in the third axis direction, and
the one or two linear radiation conductors and the planar radiation conductor are located at a same one of interfaces between the plurality of ceramic layers.

44. The multiaxial antenna of claim 29, wherein
the multiaxial antenna includes a plurality of sets of the antenna unit,
the plurality of antenna units are aligned in the second axis direction, and
the ground conductors of the plurality of antenna units are connected in the second axis direction.

45. The multiaxial antenna of claim 40, wherein
the multiaxial antenna includes a plurality of sets of the antenna unit,
the plurality of antenna units are aligned in the second axis direction, and
the ground conductors of the plurality of antenna units are connected in the second axis direction.

46. A multiaxial antenna comprising an antenna unit, the antenna unit including
a planar antenna which includes a planar radiation conductor and a ground conductor, the planar radiation conductor and the ground conductor being spaced away from each other in a third axis direction in a first right-handed Cartesian coordinate system which has first, second and third axes, and
first and second linear antennas which are spaced away from the planar antenna in a first axis direction, the first and second linear antennas including one or two linear radiation conductors extending in a second axis direction,
wherein the first linear antenna and the second linear antenna are aligned along the first axis with the planar antenna being interposed therebetween.

47. A wireless communication module comprising the multiaxial antenna as set forth in claim 40.

48. A wireless communication device comprising:
a circuit board in a second right-handed Cartesian coordinate system which has first, second and third axes, the circuit board having first and second major surfaces which are perpendicular to the third axis, first and second lateral portions which are perpendicular to the first axis, third and fourth lateral portions which are perpendicular to the second axis, and at least one of a transmission circuit and a reception circuit; and
at least one set of the wireless communication module as set forth in claim 47.
